(19) United States
(12) Patent Application Publication
(10) Pub. No.: US 2010/0243292 A1
(43) Pub. Date: Sep. 30, 2010

(54) METHOD FOR FUSING INSULATED WIRES, AND FUSED WIRES PRODUCED BY SUCH METHOD

(75) Inventors: Sean P. Telley, Fort Wayne, IN (US); Christian W. Stacey, Fort Wayne, IN (US)

Correspondence Address: BAKER & DANIELS LLP;111 E. WAYNE STREET, SUITE 800, FORT WAYNE, IN, 46802, US

(73) Assignee: FORT WAYNE METALS RESEARCH PRODUCTS CORPORATION, Fort Wayne, IN (US)

(21) Appl. No.: 12/694,779

(22) Filed: Jan. 27, 2010

Related U.S. Application Data
(60) Provisional application No. 61/148,492, filed on Jan. 30, 2009.

(51) Int. Cl. H01B 7/08; H01B 7/00; B32B 37/02

(52) U.S. Cl. 174/117 F; 174/113 R; 156/272.2

(57) ABSTRACT

A method for fusing a pair of insulated wires to one another, and a fused wire made by such method, in which the combined or major diameter of the fused wire equals, or very closely matches, the sum of the diameters of the individual wires prior to fusion. In the present method, a pair of wires, each having a coating of insulation that is substantially fully cured, are brought into close abutting contact with one another along a line contact, and thereafter pass through a heating device which heats the coatings above their a thermal transition point of at least one of the pair of wires to fuse the coatings of the wires together along the line contact.

### CROSS REFERENCE TO RELATED APPLICATION

This application claims the benefit under Title 35, U.S.C. §119(e) of U.S. Provisional Patent Application Ser. No. 61/148,492, entitled METHOD FOR FUSING INSULATED WIRES, AND FUSED WIRES PRODUCED BY SUCH METHOD, filed on Jan. 30, 2009, the entire disclosure of which is hereby expressly incorporated herein by reference.

### BACKGROUND OF THE INVENTION

1. Technical Field

The present disclosure relates to insulated wires and, in particular, relates to a method of fusing a pair of insulated wires together, and a fused wire made in accordance with such method.

2. Description of the Related Art

Insulated wires are well known for use in many applications, and are formed by coating a metal conductor wire with a coating of insulation material. The metal conductor wire may be an individual wire, or may be a strand made by twisting a plurality of individual metal wires together. Typically, the metal wires are coated by an extrusion process to form a coating or jacket of insulation material around the metal wire.

In some applications, it is desired to manufacture a dual conductor wire in which a pair of insulated metal conductor wires are joined. This dual conductor configuration physically separates, and electrically insulates, the metal conductor wires from one another. Some applications benefit from minimizing the space required to route conducting wires, and a dual conductor wire is generally more compatible with a smaller routing space as compared with two individually routed wires.

Medical applications, such as leads for cardiac rhythm management devices and neurostimulation devices, may require passage of wires through small anatomical channels. Such applications benefit from dual conductor wires, which facilitate passage of the wires through the channels and simplify layout and clamping of the wires before and during a surgical procedure.

One approach to manufacturing insulated dual conductor wires is by co-extruding the insulation material around the pair of conductor wires. However, co-extrusion has certain disadvantages and is not always a desirable method, particularly when forming dual conductor wires that need to be attached along a minimal, or line, contact such that the round cross sectional shapes of the individual insulation coatings of the individual wires is maintained.

In another method, a pair of metal conductor wires are each covered by a coating of insulation by separate extrusion processes. In one version of this method, the coated wires are placed in contact with one another soon after extrusion of the coatings, allowing residual heat from the extruded coatings to fuse the coatings of the wires together. In another version of this method, coated insulated wire pairs are first individually pre-heated, and are then subsequently brought into close contact with one another after heating such that the heated insulation coatings fuse together as the coatings set or cure.

With each of these methods, it is necessary to bring the coated wires as close to one another as possible while the insulation is heated and is not fully cured, and it is very difficult, if not impossible, to avoid deforming the insulation coatings as the wires are pressed together, such that a significant amount of the coating of one wire flows into or around, or blends into, the coating of the other wire, and vice-versa.

These processes tend to produce wires of the type shown in FIG. 1, in which an fused wire 10 made in accordance with the foregoing processes is shown. Fused wire 10 is formed from a pair of separate insulated wires 12a and 12b each including respective conductors 14a and 14b covered by insulation coating 16a and 16b and each having an initial diameter D_{A}, which diameters are shown partially in dashed lines. As may be seen in FIG. 1, when fused wire 10 is formed from a pair of wires 12a and 12b according to one of the above-described processes, significant overlap of the insulation coatings 16a and 16b of the wires 12a and 12b occurs, such that the resulting combined or major diameter D_{B} of the dual fused wire 10 is significantly smaller than the combined initial diameters D_{A} of the individual insulated wires 12a and 12b prior to formation of fused wire 10. In particular, the combined diameter D_{B} of fused wire 10 is often less than 75% of the combined initial diameters D_{A}.

What is needed is a method of fusing a pair of insulated wires to one another, and a wire made in accordance with such method, which is an improvement over the foregoing.

### SUMMARY OF THE INVENTION

The present disclosure provides a method for fusing a pair of insulated wires to one another, and a fused wire made by such method, in which the combined or major diameter of the fused wire equals, or very closely matches, the sum of the diameters of the individual wires prior to fusion. In the present method, a pair of wires, each having a coating of insulation that is substantially fully cured, are brought into close abutting contact with one another along a line contact, and thereafter pass through a heating device which heats the coatings above a thermal transition point of at least one of the pair of wires to fuse the coatings of the wires together along the line contact.

Advantageously, by the present method, insulated wires can be brought together in a close contacting adjacent relationship to ensure that the coatings of the wires are just barely touching one another prior to any heat being applied to the wires. Subsequent heating ensures that the wires are fused only along a minimal line contact between the insulation coatings, thereby minimizing or preventing deformation of the insulation coatings of the wires while producing a bond strength between the individual coatings adequate to ensure that the pair remains firmly joined. The resulting fused wire has a low pull-apart strength and a high degree of retained integrity for the individual insulation coatings. The combined diameter of the fused wire equals, or very closely matches, the combined diameters of the individual wires prior to fusion.

In one form thereof, the present invention provides a fused wire, including a first wire including a first metal conductor surrounded by a first coating of insulation, the first wire having a first diameter D₁; a second wire including a second metal conductor surrounded by a second coating of insulation, the second wire having a second diameter D₂; and the first and second wires fused together along a line contact between the first and second coatings to form the fused wire, the fused wire having a major diameter D₃, the wire further having a value Fusion % according to the following formula:

Fusion %=[D₃/(D₁+D₂)]×100% (I)

wherein Fusion % is between 75% and 99.5%.

In another form thereof, the present invention provides a method of fusing a pair of coated wires, the method including the steps of: providing at least first and second wires, each wire including a metal conductor surrounded by a coating of insulation; paying the wires outwardly from at least one spool; aligning the wires in abutting contact with one another along a line contact between the coatings of the wires; and heating the wires while maintaining the wires in abutting contact with one another along the line contact to a temperature sufficient to fuse the coatings of the wires together along the line contact.

In yet another form thereof, the present invention provides a medical device, the medical device including a first wire electrically coupled to the medical device, the first wire including a first metal conductor surrounded by a first coating of insulation, the first wire having a first diameter D₁; a second wire electrically coupled to the medical device, the second wire including a second metal conductor surrounded by a second coating of insulation, the second wire having a second diameter D₂; and at least a portion of the first and second wires fused together along a line contact between the first and second coatings to form the fused wire, the fused wire having a major diameter D₃, the fused wire further having a value Fusion % according to the following formula:

Fusion %=[D₃/(D₁+D₂)]×100% (I)

wherein Fusion % is between 75% and 99.5%, the first wire and the second wire separable along the line contact.

### BRIEF DESCRIPTION OF THE DRAWINGS

The above-mentioned and other features and advantages of this invention, and the manner of attaining them, will become more apparent and the invention itself will be better understood by reference to the following description of embodiments of the invention taken in conjunction with the accompanying drawings, wherein:

FIG. 1A is a sectional view of a fused wire made according to a known process;

FIG. 1B is a sectional view of two fused single-strand wires according to a process of the present disclosure;

FIG. 1C is a sectional view of two fused multi-strand wires according to a process of the present disclosure;

FIG. 1D is a sectional view of a larger wire fused to a smaller wire according to a process in accordance with the present disclosure;

FIG. 1E is a sectional view of round single-strand wire fused to a ribbon according to a process in accordance with the present disclosure;

FIG. 2 is a perspective view of an exemplary apparatus for manufacturing the fused wires of FIGS. 1B-1E;

FIG. 3 is a sectional view taken along line 3-3 of FIG. 2;

FIG. 4 is a sectional view taken along line 4-4 of FIG. 2;

FIG. 5 is a fragmentary view of the apparatus of FIG. 2, showing the wire straightening device;

FIG. 6 is a first schematic view of a pair of rollers of the first wire straightening assembly of the wire straightening device of FIG. 5;

FIG. 7 is a second schematic view of a pair of rollers of the first wire straightening assembly of the wire straightening device of FIG. 5;

FIG. 8 is a schematic view of a pair of rollers of the second wire straightening assembly of the wire straightening device of FIG. 5;

FIG. 9 is a fragmentary view of a portion of the apparatus of FIG. 2, showing a portion of the heating device;

FIG. 10 is a fragmentary view of a portion of the apparatus of FIG. 2, showing the measurement device;

FIG. 11 is a plot of Reduction % vs. time at temperature for Example 1, along with a best fit curve;

FIG. 12 is a plot of time at temperature vs. Reduction % for Example 1, along with a best fit curve;

FIG. 13 is a plot of thermal energy applied to a wire vs. the temperature of a heating device through which the wire passes, illustrating a desirable range of thermal energy and temperature values; and

FIG. 14 is a schematic view of a medical device with a wire in accordance with the present disclosure attached thereto.

The exemplifications set out herein illustrate embodiments of the invention, and such exemplifications are not to be construed as limiting the scope of the invention in any manner.

### DETAILED DESCRIPTION

### 1. Fused Wire Configurations

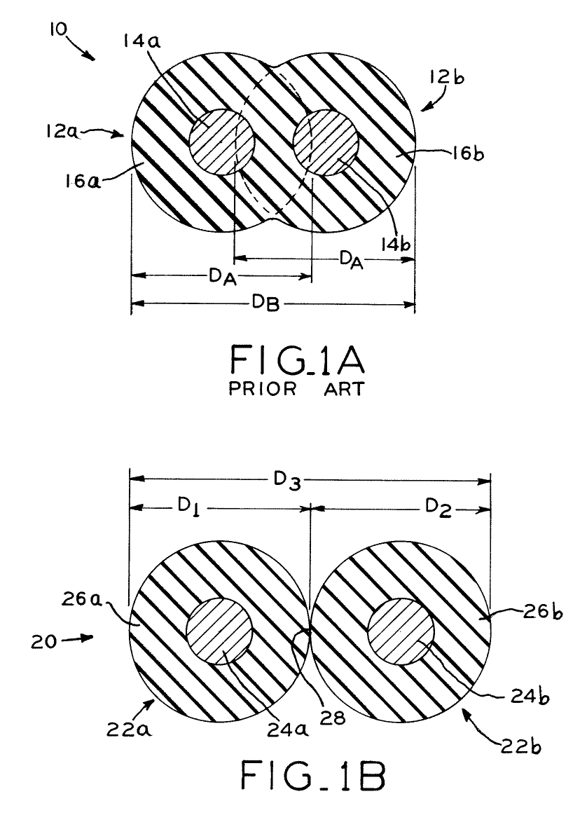

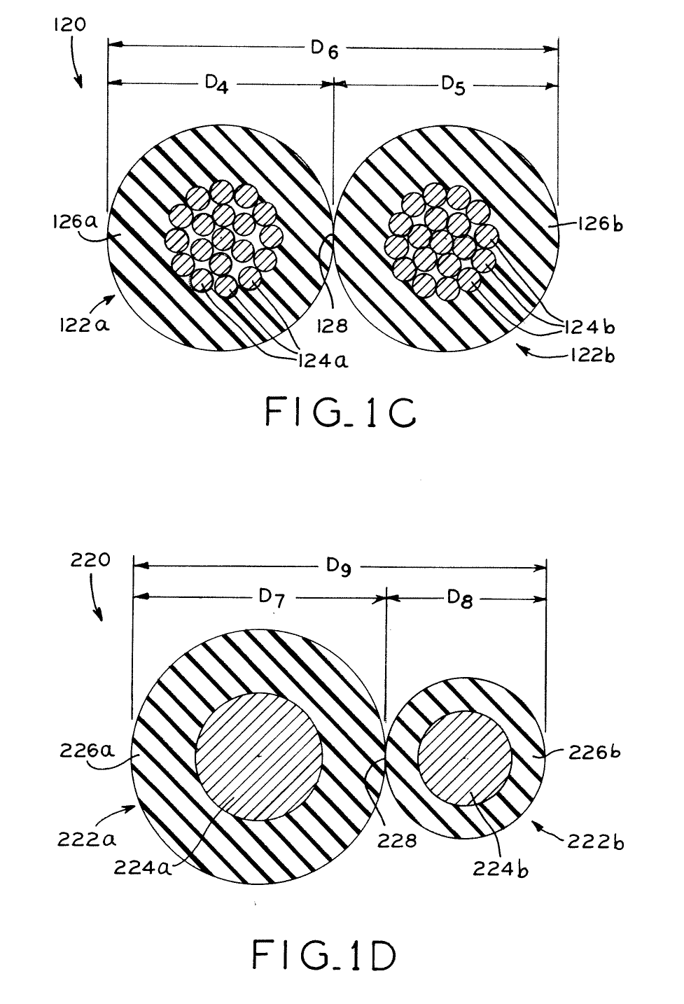

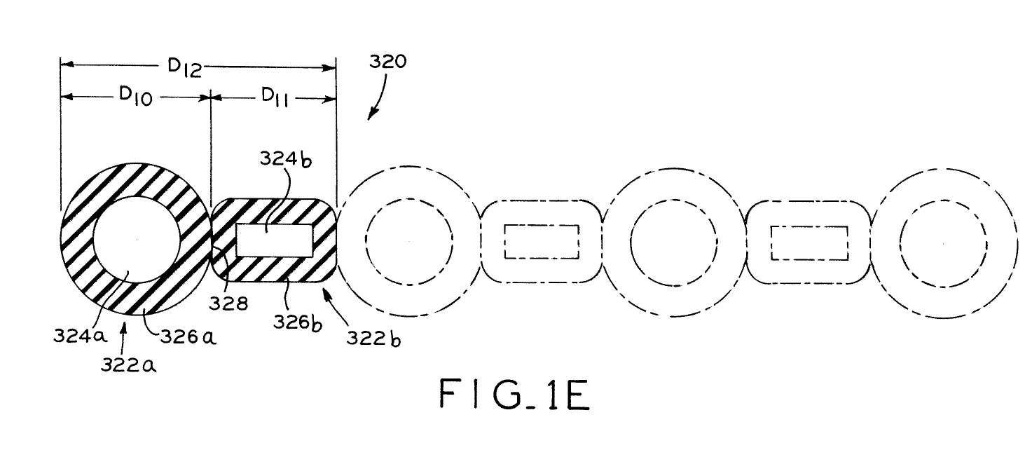

Referring to FIG. 1B, a fused wire 20 that has been produced according to the method of the present disclosure is shown. Fused wire 20 is formed from a pair of individual single strand wires 22a and 22b that include respective metal conductor wires 24a and 24b. Wires 24a and 24b are initially coated by coatings 26a and 26b, respectively, of an insulation material.

As used herein, the term “wire” or “wire product” encompasses coated and/or uncoated continuous wire, wire products and elongate conductors, whether insulated/coated or uninsulated/uncoated. Examples of “wire” or “wire products” include wire having a round cross section and wire having a non-round cross section, including flat wire or ribbon, as well as other wire-based products such as strands, cables, coil, and tubing.

In another embodiment, illustrated in FIG. 1C, fused wire 120 is formed from a pair of multi-strand wires 120a and 120b, which are formed by twisting a plurality of individual metal wires 124a and 124b together. Wires 120a and 120b are initially coated by insulation coatings 126a and 126b, respectively.

In yet another embodiment, illustrated in FIG. 1D, fused wire 220 is formed from relatively larger wire 222a and relatively smaller wire 222b that include larger metal conductor wire 224a and smaller conductor wire 224b, respectively. Wires 224a and 224b are initially coated by a relatively thick insulation coating 226a and a relatively thin insulation coating 226b, respectively.

In still another embodiment, shown in FIG. 1E, fused wire 320 is formed from wire 322a and ribbon 322b, which include metal conductor wire 324a and metal conductor ribbon 324b, respectively. Wires 324a and 324b are initially coated by wire insulation coating 326a and ribbon insulation coating 326b, respectively. An additional wire 322a may be fused to the other side of ribbon 322b to form a three-wire “barbell” configuration, or multiples of fused wire 320 may be fused to one another to form a multi-conductor “flat” ribbon cable product.

For purposes of the present disclosure, fused wire 20 will be referred to as an exemplary embodiment. However, the principles of the present disclosure apply equally to wires 120, 220, 320, or any other pairs or multiples of wires, such as three or more wires, with the insulation of the wires joined along a line contact in the manner disclosed herein. Examples of such other pairs or multiples may include shaped wires, groupings of previously fused pairs, any combination of the constituent wires of fused wires 120, 220, 320, and the like. In the manner discussed below in reference to fused wire 20, coatings 26a, 126a, 226a, 326a and 26b, 126b, 226b, 326b of wires 22a, 122a, 222a, 322a and 22b, 122b, 222b, 322b are fused together by the present method at respective fusion lines 28, 128, 228, 328 along a line contact between wires 24a, 124a, 224a, 324a and 24b, 124b, 224b, 324b with minimal, if any, overlap or deformation of coatings 26a, 126a, 226a, 326a and 26b, 126b, 226b, 326b.

Prior to fusion, wires 22a and 22b have respective diameters D₁ and D₂, and fused wire 20 includes a width along a line that connects the centers of conducting wires 24a and 24b, that will hereinafter be referred to as the overall width, or combined or major diameter D₃, of fused wire 20. The major diameter D₃ of fused wire 20 substantially or nearly equals the sum of diameters D₁ and D₂ of the individual wires 22a and 22b prior to fusion, according to the following formula (I):

Fusion %=[D₃/(D₁+D₂)]×100% (I),

where Fusion % represents D₃ as a percentage of (D₁+D₂), or the extent to which D₃ approaches (D₁+D₂). Thus, where Fusion % is a high percentage value, much or substantially all of the original widths D₁, D₂ of wires 22a, 22b is retained after the fusion process.

Alternatively, another value, Reduction %, which represents the percentage amount by which D₃ is reduced as a percentage of (D₁+D₂), may be represented by the following formula (II):

Reduction %=100%−Fusion % (II)

Reduction % can be also be calculated directly from D₁, D₂ and D₃ according to the following formula (III):

Reduction %=[[(D₁+D₂)−D₃]/(D₁+D₂)]×100% (III)

Thus, where Reduction % is a low percentage value, little or substantially none of the original widths D₁, D₂ of wires 22a, 22b is lost after the fusion process.

Representative values for Fusion % and Reduction % are as follows. Fusion % may comprise as little as 75%, 80%, 85%, 87% or 89% or as much as 90%, 93%, 95%, 97%, 99% or nearly 100%, or may be within any range delimited by these values or by the values in the Examples herein. For example, Fusion % may be between 75% and 95%, alternatively, between 90% and 97%, and further alternatively, between 95% and 99%, or greater than 99%. In one exemplary embodiment, Fusion % may be between as little as 95%, 96% or 97% and 98%, 99% and 99.9%, or may be within any range delimited by any of these values. Correspondingly, Reduction % may be 100% less the above Fusion % values, such as between 5% and 25%, alternatively, between 3% and 10%, and further alternatively, between 1% and 5%, or less than 1%. The desired values of Fusion % and Reduction % may vary depending on the diameters of the wires used and coating thicknesses. For instance, a value of 98% for Fusion % might be desirable for a pair of 0.006 inch (0.0152 cm) diameter strands coated to 0.012 inch (0.0305 cm), but not for a pair of 0.011 inch (0.0279 cm) round wires coated to 0.012 inch (0.0305 cm). Moreover, a process of producing fused wire in accordance with the present disclosure may allow a particular desired Fusion % and Reduction % to be obtained, as discussed in detail below.

Similarly to fused wire 20, wires 122a, 122b of fused wire 120 have respective diameters D₄ and D₅ which combine to produce major diameter D₆ of fused wire 120. Wires 222a, 222b have respective diameters D₇ and D_{g} which combine to produce major diameter D₉ of fused wire 220. Wires 322a has diameter D₁₀ and ribbon 322b has width D₁₁ which combine to produce major diameter D₁₂ of fused wire 320. Each of fused wires 120, 220, 320 has Fusion % and Reduction % values that are comparable to fused wire 20.

Conductor wires 24a and 24b may be made of any suitable metal, such as one or more of the following metals: titanium, chromium, niobium, tantalum, vanadium, zirconium, aluminum, cobalt, nickel, and alloys of the foregoing, stainless steels or alloys thereof. Suitable particular alloys include nitinol (nickel/titanium) and alloys conforming to the chemical compositional requirements of ASTM F562 (nominally 35 wt % Co-35 wt % Ni-20 wt % Cr-10 wt % Mo). Suitable ASTM F562 alloys include MP35N® alloys (MP35N® is a registered trademark of SPS Technologies, Inc. of Jenkintown, Pa.), such as 35N LT®, available from Fort Wayne Metals Research Products Corporation of Fort Wayne, Ind. (35N LT® is a registered trademark of Fort Wayne Metals Research Products Corporation of Fort Wayne, Ind.). Also, conductor wires 24a and 24b may be made of the same or different materials. Conductor wires 24a and/or 24b may also be constructed in a manner wherein a metal outer shell or tube is filled with another metal, and such construct is then drawn through one or more dies to reduce its diameter, such as DFT® products, available from Fort Wayne Metals Research Products Corporation of Fort Wayne, Ind. (DFT® is a registered trademark of Fort Wayne Metals Research Products Corporation of Fort Wayne, Ind.). Exemplary DFT® products useable with the process of the present disclosure are disclosed in U.S. Pat. Nos. 7,420,124 and 7,501,579, filed Sep. 13, 2004 and Aug. 15, 2005 respectively, each entitled DRAWN STRAND FILLED TUBING WIRE and commonly assigned with the present application, the disclosures of which are hereby incorporated by reference herein in their entireties. However, the material of the conductors is not thought to have a significant impact on the present fusion process.

Coatings 26a and 26b may be made of a polymeric material, such as a thermoplastic elastomer or a melt-processable fluoropolymer. Suitable fluoropolymers include polytetrafluoroethylene (PTFE), methyl fluoro alkoxy (MFA), fluoro ethylene propylene (FEP), perfluoro alkoxy (PFA), poly(chlorotrifluoroethylene), poly(vinylfluoride), co-polymers of tetrafluoroethlyene and ethylene (ETFE), polyvinylidene fluoride (PVDF), and co-polymers of tetrafluoroethylene, hexafluoropropylene, and vinylidene difluoride (THV).

Coatings 26a and/or 26b may also be formed by engineering resins or polymers. Suitable engineering polymers include PolyEther Ether Ketone (PEEK), PolyEther Sulphone (PES), PolyPhenylene Sulfide (PPS), PolyAmide Imide (PAI), Epoxy polymers, Polyester, Polyurethane (PU), Acrylic and PolyCarbonate (PC), for example.

Optionally, the coatings 26a and 26b may be pigmented with different colors to aid in differentiating the two wires 24a and 24b. Further, although coatings 26a and 26b are typically formed of the same material, it is within the scope of the present disclosure that coatings 26a and 26b (or any additional coatings) may each be formed of different materials, as discussed below.

The following are representative diameters and thicknesses of the conductor wires 24a and 24b and coatings 26a and 26b of wires 22a and 22b (FIG. 1B) that may be fused according to the present process. For wires 22a and 22b in which conductor wires 24a and 24b formed of round wires, same may have diameters D₁, D₂ ranging from about 0.002 inch (0.0051 cm) to 0.015 inch (0.0381 cm), with the thickness of coatings 26a and 26b ranging from 0.00075 inch (0.0019 cm) to 0.010 inch (0.0254 cm). In one exemplary embodiment discussed in Example 1 below, wires 22a and 22b may have individual diameters D₁, D₂ prior to fusion of about 0.01205 inch (0.0306 cm) including conductor wires 24a and 24b and coatings 26a and 26b), and a fused combined diameter of between about 0.02312 inch (0.0587 cm) and 0.02381 inch (0.0605 cm). Thus, following Formula (I) above, Fusion % for this exemplary embodiment is between about 95.95% and about 98.75%.

In an exemplary embodiment of fused wire 120 (FIG. 1C), multi-strand wires 120a and 120b may have an overall diameter ranging from about 0.002 inch (0.0051 cm) to 0.015 inch (0.0381 cm). In the illustrated embodiment of FIG. 1C, the overall diameters D₄, D₅ of the multi-strand wires is 0.01205 inch (0.0306 cm), with the plurality of individual metal wires 124a and 124b having individual diameters of 0.0012 inch (0.0030 cm). The thickness of insulation coatings 126a and 126b may range from about 0.00075 inch (0.0019 cm) to 0.010 inch (0.0254 cm). In the illustrated embodiment of FIG. 1C, the thickness of coatings 126a and 126b is 0.003 inch (0.0076 cm). After wires 120a, 120b are fused together into fused wire 120, combined diameter D₆ is about 0.0236 inch (0.0599 cm). Thus, following Formula (I) above, Fusion % for this exemplary embodiment is about 97.93%.

In an exemplary embodiment of fused wire 220 (FIG. 1D), relatively larger wire 222a may have an overall diameter D₇ of about 0.0082 inch (0.0208 cm), while relatively smaller wire 222b may have an overall diameter D_{g} of about 0.005 inch (0.0127 cm). The thicknesses of the relatively thick insulation coating 226a and the relatively thin insulation coating 226b may be about 0.0021 inch (0.0053 cm) and 0.001 inch (0.0025 cm), respectively. After wires 220a, 220b are fused together into fused wire 220, combined diameter D₉ is about 0.0129 inch (0.0328 cm). Thus, following Formula (I) above, Fusion % for this exemplary embodiment is about 97.73%.

In an exemplary embodiment of fused wire 320 (FIG. 1E), wire 322a may have an overall diameter D₁₀ of about 0.0082 inch (0.0208 cm), while ribbon 322b has overall dimensions of about 0.015 inch (0.0381 cm) width (i.e., D₁₁) and about 0.008 inch (0.0203 cm) height. The thickness of wire insulation coating 326a may be about 0.00211 inch (0.0054 cm), while ribbon insulation coating 326b may have a thickness of about 0.0015 inch (0.0038 cm). Fused wire 320 has a “lollipop” cross sectional profile, with wire 322a positioned atop ribbon 322b. This “lollipop” profile may form the building block for a ribbon cable product, in which several fused wires 320 are placed end-to-end to create an alternating round/flat/round profile to create a “flat” multi-conductor cable. A three-conductor cable with a “dumbell” cross-sectional profile may also be created by fusing two of wires 322a to each of the two shorter faces of ribbon 322b. After wires 320a, 320b are fused together into fused wire 320, combined diameter D₁₂ is about 0.0225 inch (0.0572 cm). Thus, following Formula (I) above, Fusion % for this exemplary embodiment is about 96.98%.

The dimensions given above with respect to FIGS. 1B-1E are exemplary, and these dimensions may vary substantially in other wires and wire products produced in accordance with the present disclosure.

### 2. Method of Manufacturing Fused Wires in Accordance with the Present Disclosure

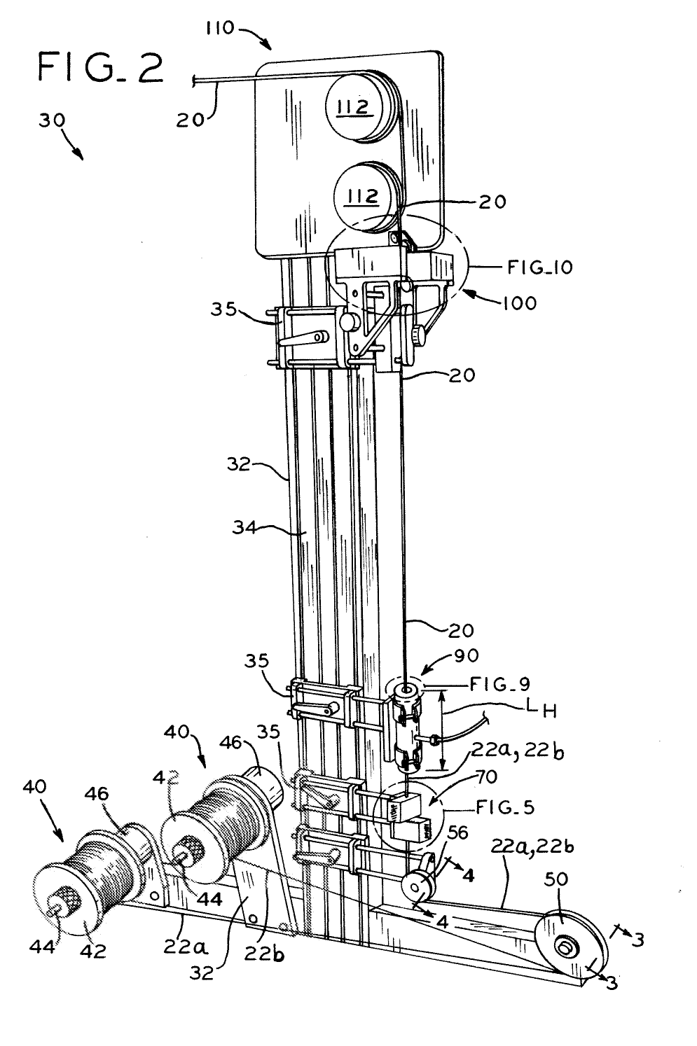

Referring to FIG. 2, an apparatus 30 for carrying out the present method is shown. Wire fusion apparatus 30 generally includes a frame 32, which may be any structure capable of supporting the various components of the apparatus 30 as described below. In one embodiment, frame 32 includes a vertical rail member 34 with one or more channels into which a plurality of trolleys 35 are received. The trolleys 35 are adjustably fixable to, and selectively locatable along, the rails 34 for supporting the various components of the apparatus 30 as described below. However, the apparatus 30 may be configured in any manner suitable in accordance with the present method, which is discussed in detail below.

A pair of payout assemblies 40 support spools 42 of insulated wires 22a and 22b, and generally include shafts 44 to which spools 42 are mounted. As described below, a capstan apparatus 110 pulls wires 22a and 22b, and the resulting fused wire 20, through the apparatus 30 and provides tension to these wires as same move through apparatus 30. Payout assemblies 40 may include back-tensioning elements for providing a back tension or resistance to the wires 22a and 22b throughout their travel though apparatus 30. In one embodiment, the back-tensioning elements are magnetic clutches 46 which operate to apply a braking force to shafts 44 on which spools 42 are mounted. Magnetic clutches 46 may be adjustable independently of one another to provide differing amounts of braking force to shafts 44 to thereby vary the back tension or resistance as needed, such as when the mass or diameter of one spool 42 differs from the other and/or to otherwise allow independent control over the payout of wires 22a and 22b from spools 42.

The independent payout wire tensions provided by the pair of back-tensioning elements are also useful when the construction or sizing of wires 22a and 22b varies. For example, if a first wire having a large round conductor, such as wire 224a (FIG. 1D) is to be fused to a second wire having a conductor formed of a similarly-sized strand, the first and second wires will each require an upward adjustment tension as compared to wires 22a and 22b. Also, if a first wire having a large round conductor is to be fused to a second wire having a small round conductor, such as wires 224a and 224b in fused wire 220 (FIG. 1D), the first wire will require an upward adjustment of tension while tension in the second wire may remain lower.

Spools 42 each hold respective lengths of wires 22a, 22b, which wires have been previously coated with their respective coatings 26a, 26b of insulation of the type described above by any extrusion-type process, for example, and wherein the insulation of coatings 26a, 26b has substantially or fully cured prior to the wire fusion process discussed below. By substantially or fully cured, it is meant that the insulation material of coatings 26a, 26b has set, cooled, and cured to the point where the material is no longer tacky, and wires 22a and 22b are therefore able to be rolled onto spools 42, and thence unrolled from spools 42, while maintaining the shape and dimensional integrity of the insulation material.

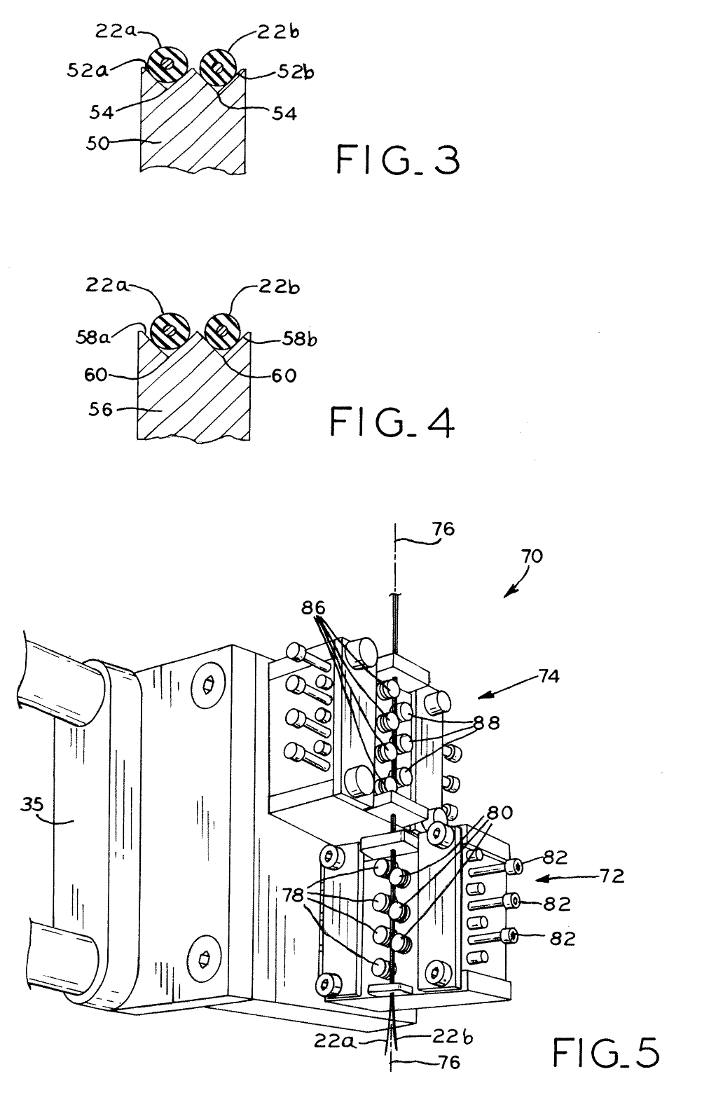

After wires 22a and 22b are paid out from spools 42, same are wrapped around a first pulley 50 which, as shown in FIG. 3, includes a pair of grooves 52a and 52b respectively receiving wires 22a and 22b and maintaining wires 22a and 22b spaced slightly apart from one another. In one embodiment, grooves 52a and 52b are V-shaped, and the apexes 54 of the grooves are spaced apart from one another. Grooves 52a and 52b are shown with substantially equal sizes and geometries, as appropriate for wires 22a and 22b. For wires of differing size and/or geometry, such as wires 222a, 222b of fused wire 220 or wire 322a and ribbon 322b of fused wire 320, the size and/or geometry of grooves 52a and 52b is adjusted accordingly. As shown in FIG. 2, wires 22a and 22b are turned around pulley 50 such that the direction of wires 22a and 22b is reversed, i.e., wires 22a and 22b make 180° and 190° turns, respectively. In other embodiments, wires 22a and 22b may make a lesser or greater turn around pulley 50, such as between 90° and 270°, and in one embodiment, wires 22a and 22b are turned around pulley 50 about 150°.

Wires 22a and 22b are then wrapped around a second pulley 56 which, as shown in FIG. 5, includes a pair of grooves 58a and 58b respectively receiving wires 22a and 22b and maintaining wires 22a and 22b spaced slightly apart from one another. In one embodiment, grooves 58a and 58b are V-shaped, and the apexes 60 of the grooves are spaced apart from one another. Similar to grooves 52a and 52b, grooves 58a and 58b are shown with substantially equal sizes and geometries. For wires of differing size and/or geometry, the size and/or geometry of grooves 58a and 58b may also be adjusted accordingly. As shown in FIG. 2, wires 22a and 22b are turned around pulley 56 such that the direction of wires 22a and 22b is moved from horizontal to vertical, i.e., wires 22a and 22b make a 90° turn. In other embodiments, wires 22a and 22b may make a greater or lesser turn around pulley 56, such as any turn less than 180° and, in one particular embodiment, wires 22a and 22b are turned around pulley 56 about 135°.

First and second pulleys 50 and 56 tension the wires 22a and 22b apart from one another, allowing the wire straightening device 70, shown in FIG. 5 and described below, to bring the wires 22a and 22b in abutting contact with one another along a line contact in the manner described below. First and second pulleys 50 and 56 also direct wires 22a and 22b in parallel relation to one another along the vertical progression direction of the apparatus 30, and second pulley 56 reinforces the spacing between the wires 22a and 22b which is initially provided by pulley 50, which provides lateral tension to the wires 22a and 22b to facilitate bringing the wires 22a and 22b into positive but light contact with one another in wire straightening device 70, described below.

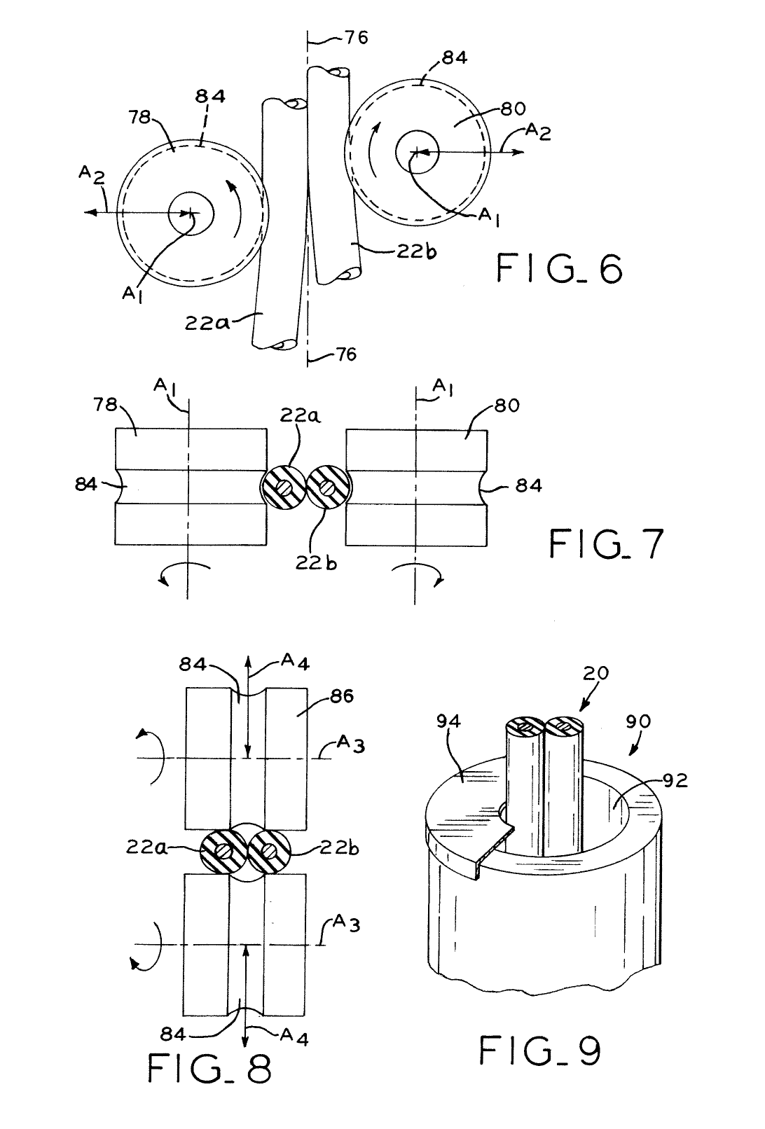

Referring generally to FIGS. 5-8, wires 22a and 22b enter a wire straightening device 70 after traveling around pulleys 50, 56. As shown in FIG. 5, wire straightening device 70 generally includes a first straightening assembly 72, and a second straightening assembly 74 which is oriented at 90° with respect to first straightening assembly 72. First and second straightening assemblies 72 and 74 are together oriented along a nominal axis 76 of the device 70 which corresponds to, i.e., is coaxial with, the vertical progression direction or wire path of wires 22a and 22b through the apparatus 30 following the exit of wires 22a and 22b from second pulley 56. First straightening assembly 72 includes a row of first rollers 78 and a row of second rollers 80, each disposed parallel to nominal axis 76. Each roller 78 and 80 is independently laterally adjustable with respect to axis 76 by its associated thumb screw 82 or other manual adjustment device, so that roller 78 and/or roller 80 can be advanced toward or away from the wire path illustrated as nominal axis 76. As shown in FIGS. 6 and 7, each roller 78 and 80 includes a small groove 84 (FIGS. 6 and 7) for receipt of a respective wire 22a or 22b, and rollers 78 and 80 are rotatable on respective central axes A₁ which are perpendicular to nominal axis 76.

In first straightening assembly 72, wire 22a is received within grooves 84 of first rollers 78 in the first row, and wire 22b is received within grooves 84 of rollers 80 in the second row. Thumb screws 82, shown in FIG. 5, are used to laterally adjust rollers 78, 80 independently toward and away from nominal axis 76 of the device 70, i.e., along the directions of arrows A₂ in FIG. 6 to advance roller 78 and/or roller 80 toward or away from the wire path illustrated as nominal axis 76. Rollers 78, 80 are adjusted in order to bring wires 22a and 22b in light abutting contact with one another such that their respective coatings 26a and 26b just barely touch one another along a line contact corresponding to nominal axis 76. Due to the size of device 70 in the illustrated embodiment, a magnifying glass or other magnification device may be used by an operator to manually adjust each of thumb screws 82 to thereby set the distance between the rollers 78 and 80 of the first and second rows such that wires 22a and 22b having coatings 26a and 26b of a given thickness are brought into light abutting contact with one another along a line contact. In this manner, first straightening assembly 74 may be adjusted for wires 22a and 22b of any given thickness.

Second straightening assembly 74 (FIG. 5) includes a row first rollers 86 and a second row of rollers 88, each disposed parallel to nominal axis 76. However, as shown in FIGS. 5 and 8, rollers 86 and 88 are oriented 90° with respect to the rollers 78 and 80 of first straightening assembly 74, and contact both of wires 22a and 22b on respective opposite sides of wires 22a and 22b to maintain wires 22a and 22b in the same plane, which is parallel to nominal axis 76. Rollers 86 and 88 are rotatable on respective central axes A₃ (FIG. 8) which are perpendicular to nominal axis 76, and thumb screws 82 are used to laterally adjust rollers 86 and 88 independently toward and away from axis nominal 76 of the device 70, i.e., along the directions of arrows A₄ in FIG. 8.

The light abutting contact of wires 22a and 22b provided by the rollers 78, 80, 86, and 88 of wire straightening device 70 is important for overcoming the following potential disadvantages that are present in known processes. First, heavier contact can mar the surfaces of the coatings of wires 22a and 22b. In particular, small coating thicknesses may mar, leading to scuffs, flat spots, etc., with very little force. Second, the peaks and valleys of strands and cables that may be used for the conductors of wires 22a and 22b can be relatively extreme. If the strand or cable peaks of the parallel wires 22a and 22b are aligned, the passage of wires 22a and 22b through a bottleneck created by the rollers 78, 80, 86, and 88 of wire straightening device 70 could potentially reduce the thickness of the insulation coating at that point. Third, heavy contact applied to strands and cables could potentially deform the coated strands from round to oval in shape. Finally, heavy contact may tend to cause the pair of wires 22a and 22b to twist out of the desired plane of alignment provided by the rollers 78, 80, 86, and 88 of wire straightening device 70. Moreover, the light abutting contact of wires 22a and 22b provided by rollers 78, 80, 86, and 88 facilitates a thermal joining or fusion of wires 22a and 22b along a line contact to form fused wire 20, as discussed below. Although several rollers 78, 80, 86, 88 are shown in the illustrated embodiment, fewer rollers may be used.

For fused wires 120, 220, 320 or other fused wire products, the geometry of grooves 84 and/or spacing of rollers 78, 80 and 86, 88 may be adjusted. For example, groove 84 on one of rollers 78, 80 may be made larger to accommodate larger wire 222a (FIG. 1D). Alternatively, groove 84 on one of rollers 78, 80 may have a rectangular shape to accommodate ribbon 322b (FIG. 1E). The spacing between rollers 86, 88 may be enlarged to accommodate the larger of a differently sized pair of wires, or rollers 86, 88 may be eliminated altogether.

After exiting wire straightening device 70, wires 22a and 22b are maintained in light abutting contact with one another such that their respective coatings 26a and 26b are just barely touching one another along a line contact. Wires 22a and 22b then enter heating device 90 positioned downstream, or above, wire straightening device 70. Heating device 90 may be a convection-type heater, for example, which includes two thick-walled aluminum tubes heated by three heater bands, with two heater bands on one tube, and one on the other. Referring additionally to FIG. 9, the tubes define an interior heating chamber 92, and are placed within a few inches of the exit of the wire straightener 70. The temperature in chamber 92 is held at a selected target by digital heater controllers, and a suitable gasket 94, having an opening for fused wire 20 to pass therethrough, may be placed on the upper end of heating device to minimize heat loss from chamber 92.

Heating device 90 is used to apply thermal energy to wires 22a, 22b as they pass through heating chamber 92. In order to apply a desired amount of thermal energy over a particular time interval, several variables may be manipulated within apparatus 30. These variables include temperature in heating chamber 92, the length L_{H} of heating device 90, and the line speed of wires 22a, 22b.

Heating device 90 has length L_{H}, which may be lengthened or shortened to change the time of exposure of wires 22a, 22b to heating chamber 92. Such lengthening may be accomplished by using different lengths of heating device 90, or by stacking multiple short heating devices 90, one atop the other.

Another variable affecting the overall amount of thermal energy imparted to wires 22a, 22b in heating chamber 92 is the line speed of wires 22a, 22b. The speed of progression of wires 24a and 24b through heating device 90, i.e., the elapsed time between when a given point on wires 24a and 24b is exposed to the elevated temperature in heating device 90 and when such point exits heating device 90, referred to herein as “time at temperature,” may be varied to affect the extent of fusion of the wires. For a given length L_{H} and configuration of heating device 90, and a given temperature of heating chamber 92, the speed at which wires 22a, 22b pass through chamber 92 determines the time at temperature by the following equation (IV)

T_{T}−L_{H}/WS, (IV)

where T_{T} is the time at temperature, L_{H} is the length of heating device 90, and WS is the linear speed of the wire as it passes through the heating device.

To achieve a desired temperature of coatings 26a, 26b, such as a thermal transition temperature as discussed below, length L_{H}, time at temperature, and/or the temperature within chamber 92 may be increased. Alternatively, the desired temperature may be achieved even where one or more variables are decreased, provided that another variable is increased sufficiently. For example, at a given temperature in chamber 92, line speed may be increased where length L_{H} is also increased. Alternatively, the temperature in chamber 92 may be increased to compensate for a shorter length L_{H} and/or a faster line speed. Advantageously, this control over the variables affecting fusion of wires 22a, 22b facilitates prediction of, and control over, the value obtained for Fusion % and Reduction % in the finished product.

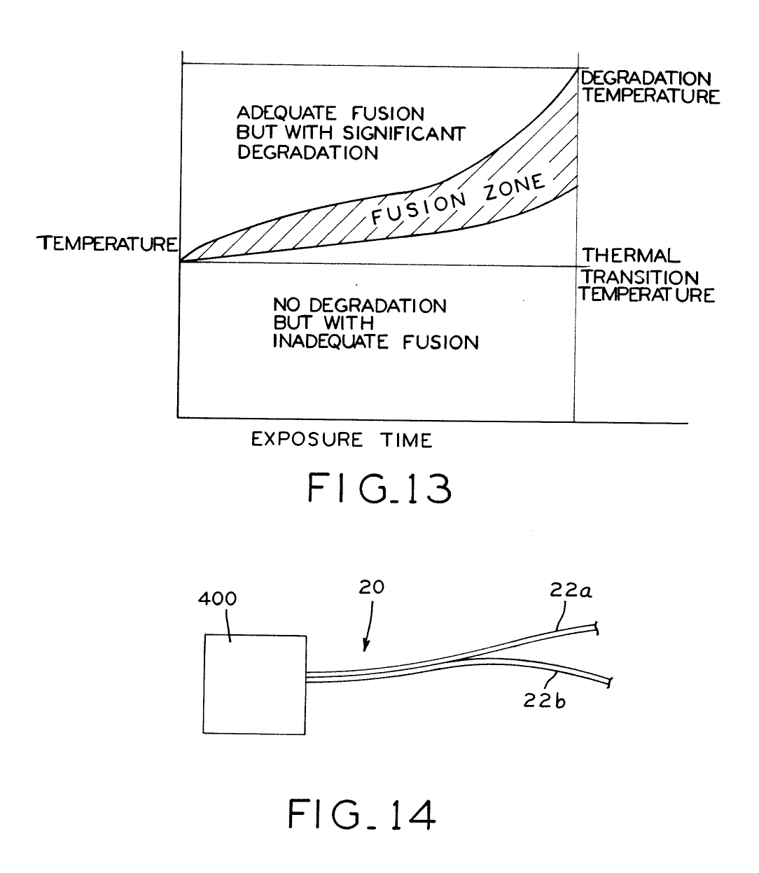

For some materials, the temperature of chamber 92 should be kept low enough to prevent scorching of coatings 26a, 26b, where coatings 26a, 26b burn or degrade rather than fuse. Referring to FIG. 13, the relationship of heating chamber temperature vs. exposure time of wires 22a, 22b to that temperature is shown. At relatively low temperatures, i.e., temperatures at or near the thermal transition temperature of a given coating material, longer exposure times will be required to reach the “fusion zone” where proper fusion occurs in accordance with the present disclosure. If temperature is too low and/or exposure is too short, no degradation of coatings 26a, 26b will occur, but fusion will also not occur or will be insufficient to adequately bond wires 22a, 22b. Exposure time can be shortened by increasing temperature, but if temperature is raised too high for a given exposure time, degradation or “scorching” of coatings 26a, 26b Occurs.

In heating device 90, the insulation material of coatings 26a and 26b of wires 22a and 22b is heated to just above the softening or thermal transition point of the material, such that, along the line contact between coatings 26a and 26b, coatings 26a and 26b fuse with one another to form fused wire 20. Where coating 26a has a different thermal transition temperature as compared to coating 26b, such as where coatings 26a and 26b are made of a different materials, wires 22a, 22b may be heated to a temperature corresponding with the lower of the different thermal transition temperatures. When so heated, one of coatings 26a, 26b bonds to the other of coatings 26a, 26b along the line contact between coatings 26a and 26b to fuse the thermally transitioned coating to the non-thermally transitioned coating.

As used herein, a “thermal transition” point or temperature refers to the conditions at which a material undergoes a change in material properties consistent with a change in temperature. For example, a thermal transition point for a crystalline polymer may be the temperature at which the solid begins to melt at a given pressure. On the other hand, the thermal transition point for an amorphous or partially crystalline polymer may be the glass transition temperature at a given pressure.

Examples of thermal transition temperatures for some exemplary polymers (as discussed above) at atmospheric pressure are as follows: ETFE has a melt temperature of about 500 deg. Fahrenheit/260 deg. Celsius; PEEK has a glass transition temperature of about ˜143° C. and a melt point about ˜343° C.; PES has a glass transition temperature of about ˜193° C. and a melt point of about 255° C., depending on grade; PPS has a glass transition temperature of about 85° C. and melting point of about ˜285° C.; PAI has a glass transition temperature of about 280° C.; and polyesters have glass transitions in the region of (but not limited to) 70° C. and melt points ˜265° C. PU glass transitions and melt points depending on polymer matrix and application, while epoxy glass transition temperature and melt point vary dependent upon the polymer backbone.

In an exemplary embodiment, coatings 26a and 26b are made of ETFE with a thermal transition temperature of about 500 deg. Fahrenheit, and are fused into fused wire 20 using a length L_{H} of heating device 90 of 7.5 inches (19.1 cm), a line speed ranging from between 2.4 and 12.2 ft/min (73.2 and 371.9 cm/min), and a temperature in chamber 92 ranging from 490 to 720 degrees fahrenheit (254.4 to 382.2 degrees Celsius).

With subsequent cooling downstream of heating device 90 with wires 22a and 22b maintained in light abutting contact with one another along the line contact at which the coatings 26a and 26b are fused, the insulation material of the coatings 26a and 26b will fully cure to connect the wires 22a and 22b along the line contact. Due to the vertical orientation of apparatus 30 and the vertical progression direction of wires 22a and 22b through apparatus 30, potential gravity-based deformation of the coatings 26a and 26b within, and downstream of, heating device 90 is prevented.

Advantageously, because wires 22a and 22b are brought into, and maintained in light abutting contact with one another along the fusion line 28, wires 22a and 22b are not physically pressed against one another which, upon heating and softening of coatings 26a and 26b, would cause coatings 26a and 26b to be pressed into and merged with one another as discussed above with reference to FIG. 1A, and/or otherwise causing deformation of the insulation material and the shape of the coatings 26a and 26b. The lack of deformation or marring of wires 22a and 22b, together with the line contact fusion described herein, produces a fused wire 20 in which the dimensional characteristics of individual wires 22a, 22b is substantially maintained. These dimensional characteristics may include: concentricity of wires 24a, 24b with coatings 26a, 26b respectively; integrity of coatings 26a, 26b, particularly along the fusion line 28; and the uniformity of the thickness of coatings 26a, 26b. Thus, fused wire 20 exhibits little or no degradation in ratings for voltage and/or amperage, so that the individual power transmission capabilities of wires 22a, 22b are substantially retained even after the fusion process. This power-transmission retention is particularly beneficial for certain applications, such as cardiac rhythm management, where fused wire 20 may be required to withstand repetitive and/or continuous transmissions of relatively large amounts power.

Also advantageously, wires 22a and 22b may be separated from one another without significantly compromising the integrity, uniformity or dimensional characteristics of coatings 26a, 26b. The force required to break the chemical bonds formed along fusion line 28 is substantially lower as compared to a traditional fused wire, such that applying the force will not result in wires 22a, 22b experiencing stress sufficient to damage or deform the material of coatings 26a or 26b. Thus, wires 22a, 22b also exhibit little or no degradation in ratings for voltage and/or amperage, so that the individual power transmission capabilities of wires 22a, 22b are substantially retained even after wires 22a, 22b have been separated from fused wire 20.

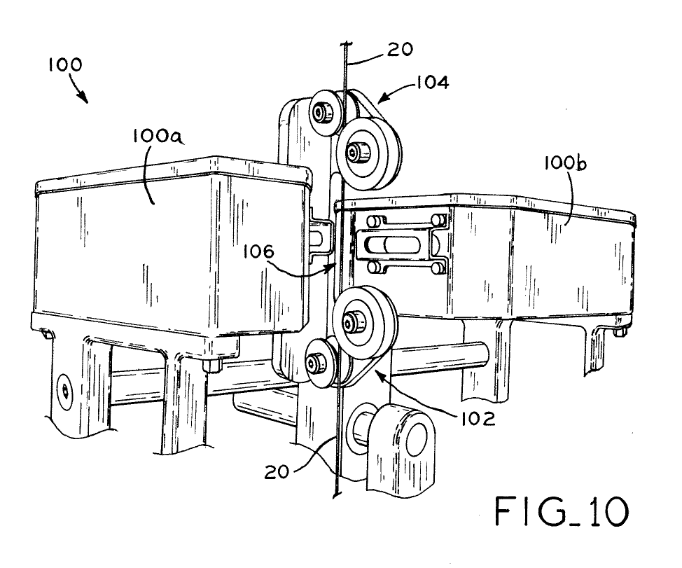

After the fusion process is complete, the fused wire 20 is passed through a measurement device, shown in FIG. 10. In one embodiment, the measurement device may include a laser micrometer 100, and associated pairs of first pulleys 102 and 104 for maintaining the vertical orientation of fused wire 20. Laser micrometer 100 generally includes a pair of modules 100a and 100b defining a gap space 106 through which fused wire 20 passes. One or more lasers are directed between modules 100a and 100b, are oriented perpendicular to the progression direction of fused wire 20, and are used to measure the combined diameter D₃ of fused wire 20.

After exiting laser micrometer 100, fused wire 20 is directed around a pair of wheels 112 of a capstan device 110, and is thereafter fed onto a spool on a take-up device (not shown) which includes an accumulator, a spark test chamber, and a foot-counting device. At least one of the wheels 112 of the capstan device is driven or powered and functions to pull the wires 22a and 22b, and the resulting fused wire 20, and thereby apply tension throughout the apparatus 30. Fused wire 20 may be wrapped multiple times around each of wheels 112 to impart adequate frictional force to prevent slippage of wire 20 with respect to wheels 112. Alternatively a device having multiples wheels 112 may be used, where wheels 112 may be staggered. One or more of the wheels 112 may be driven, with wires fused wire 20 having a substantial wrap angle around each of wheels 112, such as at least 180 degrees. The wrap angle and number of wheels cooperate to produce a large area of contact between fused wire 20 and wheels 112, thereby minimizing or eliminating slippage of fused wire 20 with respect to the surface of wheels 112.

### 3. Apparatuses Using Fused Wires in Accordance with the Present Disclosure

Wires made in accordance with the present disclosure may be useable with a variety of medical device applications where multiple wires are fused along at least a portion of the wires' lengths.

For example, biostimulation devices such as cardiac pacing devices, neurostimulation devices, and the like may have a power source coupled to an anatomical structure, such as the heart or neural pathways, via electrically conducting wire. The wire transmits power from the power source to the anatomical structure via positive and negative leads, each of which may be attached to a different part of the anatomical structure.

In some cases, the wire must be passed through small spaces within the body of the patient in order to route the wire from the power source to the power delivery site. To facilitate this routing, multiple wires are joined into a single fused wire, such as fused wire 20 discussed above, which may be passed through the body as a unitary whole. When the individual components of the wire, such as wires 22a, 22b of wire 20 reach the anatomical structure, the fused wire must be split to allow each wire to be routed to different portions of the anatomic structure.

Advantageously, fused wire 20 is well suited to such an application because fused wire 20 may be easily and uniformly split into wires 22a, 22b without significantly compromising coatings 26a, 26b of wires 22a, 22b, as discussed above. Alternatively, wires 22a, 22b may be coupled with a processor or computer for transmitting sensor signals, rather than for power transmission. Further, multiples of fused wire 20, or a multiple-conductor wire as discussed above, may be used for both power and signal transmission.

In an exemplary embodiment, medical device 400 may be implanted into the body of a patient, or may be carried on the person of a patient. Fused wire 20 (or fused wires 120, 220, 320 or other fused wires as discussed above) has wires 22a, 22b electrically coupled with medical device 400. For example, metal conductor wire 24a of wire 22a may be electrically coupled to the “positive” terminal of a power source of medical device 400, while metal conductor wire 24b of wire 22b may be electrically coupled to a “negative” terminal of the power source. At the other end of fused wire 20, wires 22a and 22b are separated along fusion line 28 so that metal conductor wires 24a, 24b may be connected to different portions of an anatomical structure. For example, medical device 400 may be a cardiac pacing device, with wires 22a, 22b coupled to the atrium and ventricle of a heart, respectively. Medical device 400 may also be a neurostimulation device, with wires 22a, 22b coupled to the spinal cord, cranial nerves, vagus nerves, or peripheral nerves, for example.

### EXAMPLES

The following Examples illustrate various features and characteristics of the present invention, which is not to be construed as being limited thereto.

### Example 1

### Fusion of Wire Pairs Made from 316LVM, 35N LT®, and Pt/10% Ir Conductors Having ETFE Coatings

In this Example, wire pairs were fused using the above-described apparatus. The wires had coatings formed from an ethylene tetrafluoroethylene copolymer (ETFE) and had outer diameters (D₁ and D₂) of 0.0121 inch (0.0307 cm). The spacing between the apexes 54 of grooves 52a and 52b of pulley 50, and the spacing between the apexes 60 of grooves 58a and 58b of pulley 56, were each 0.09 inch (0.2286 cm).

As set forth in Table 1 below, the wires had conductors made from 316LVM stainless steel, 35N LT® (an MP35N alloy available from Fort Wayne Metals Research Products Corporation of Fort Wayne, Ind.), and an alloy of 90% platinum/10% iridium (Pt10/Ir). Seven runs were conducted, each using two wires of the given construction and under the conditions set forth in Table 1 below. In each run, a laser micrometer measurement device was used to measure the combined or major diameter D₃ of the fused wire every second, with the average values of these measurements set forth in Table 1 below.

TABLE 1

| | | | | | Time | | | |
|---|---|---|---|---|---|---|---|---|
| | Conductor/ | D₁ & D₂ | Temp | Speed | @ temp | Average D₃ | | |
| # | Coating | (in/cm) | (° F./° C.) | (ft/min/cm/min) | (s) | (in/cm) | Reduction % | Fusion % |
| 1 | 316LVM/ | 0.0121/ | 490/ | 2.4/ | 14.583 | 0.023487/ | 2.943 | 97.057 |
| | ETFE | 0.0307 | 254.4 | 73.2 | | 0.059657 | | |
| 2 | 316LVM/ | 0.01205/ | 500/ | 3.5/ | 10.714 | 0.023611/ | 2.028 | 97.972 |
| | ETFE | 0.0306 | 260 | 106.7 | | 0.059972 | | |
| 3 | 316LVM/ | 0.0121/ | 500/ | 3.5/ | 9.999 | 0.023611/ | 2.433 | 97.567 |
| | ETFE | 0.0307 | 260 | 106.7 | | 0.059972 | | |
| 4 | 316LVM/ | 0.0121/ | 500/ | 4.0/ | 8.75 | 0.023578/ | 2.569 | 97.432 |
| | ETFE | 0.0307 | 260 | 121.9 | | 0.059888 | | |
| 5 | 316LVM/ | 0.01205/ | 500/ | 4.0/ | 9.375 | 0.023578/ | 2.164 | 97.836 |
| | ETFE | 0.0306 | 260 | 121.9 | | 0.059888 | | |
| 6 | 316LVM/ | 0.01205/ | 500/ | 4.0/ | 9.375 | 0.023596/ | 2.092 | 97.909 |
| | ETFE | 0.0306 | 260 | 121.9 | | 0.059934 | | |
| 7 | Pt10/Ir/ | 0.0121/ | 650/ | 6.0/ | 5.833 | 0.023613/ | 2.425 | 97.575 |
| | ETFE | 0.0307 | 343.3 | 182.3 | | 0.059977 | | |
| 8 | 35N LT ®/ | 0.01205/ | 650/ | 7.0/ | 5.357 | 0.023798/ | 1.253 | 98.747 |
| | ETFE | 0.0306 | 343.3 | 213.4 | | 0.060447 | | |
| 9 | 35N LT ®/ | 0.0121/ | 650/ | 7.0/ | 5 | 0.023798/ | 1.661 | 98.339 |
| | ETFE | 0.0307 | 343.3 | 213.4 | | 0.060447 | | |
| 10 | Pt10/Ir/ | 0.01205/ | 650/ | 6.0/ | 6.25 | 0.023613/ | 2.020 | 97.980 |
| | ETFE | 0.0306 | 343.3 | 182.3 | | 0.059977 | | |
| 11 | 316LVM/ | 0.01205/ | 650/ | 9.0/ | 4.167 | 0.023124/ | 4.050 | 95.950 |
| | ETFE | 0.0306 | 343.3 | 274.3 | | 0.058735 | | |
| 12 | 316LVM/ | 0.01205/ | 650/ | 9.5/ | 3.947 | 0.023624/ | 1.974 | 98.027 |
| | ETFE | 0.0306 | 343.3 | 289.6 | | 0.060005 | | |
| 13 | 316LVM/ | 0.01205/ | 650/ | 10.1/ | 3.713 | 0.02374/ | 1.495 | 98.505 |
| | ETFE | 0.0306 | 343.3 | 307.8 | | 0.06030 | | |
| 14 | 316LVM/ | 0.01205/ | 650/ | 10.3/ | 3.641 | 0.02372/ | 1.576 | 98.424 |
| | ETFE | 0.0306 | 343.3 | 313.9 | | 0.06025 | | |
| 15 | 316LVM/ | 0.01205/ | 650/ | 10.5/ | 3.571 | 0.023729/ | 1.540 | 98.460 |
| | ETFE | 0.0306 | 343.3 | 320.0 | | 0.060272 | | |
| 16 | 316LVM/ | 0.0121/ | 720/ | 10.0/ | 3.5 | 0.023754/ | 1.841 | 98.159 |
| | ETFE | 0.0307 | 382.2 | 304.8 | | 0.060335 | | |
| 17 | 316LVM/ | 0.01205/ | 720/ | 11.0/ | 3.409 | 0.023615/ | 2.015 | 97.985 |
| | ETFE | 0.0306 | 382.2 | 335.3 | | 0.059982 | | |
| 18 | 316LVM/ | 0.01205/ | 720/ | 11.2/ | 3.348 | 0.023655/ | 1.758 | 98.242 |
| | ETFE | 0.0306 | 382.2 | 341.4 | | 0.060084 | | |
| 19 | 316LVM/ | 0.01205/ | 720/ | 11.5/ | 3.261 | 0.023655/ | 1.847 | 98.153 |
| | ETFE | 0.0306 | 382.2 | 350.5 | | 0.060084 | | |
| 20 | 316LVM/ | 0.0121/ | 720/ | 12.0/ | 2.917 | 0.023808/ | 1.622 | 98.378 |
| | ETFE | 0.0307 | 382.2 | 365.8 | | 0.060472 | | |
| 21 | 316LVM/ | 0.01205/ | 720/ | 12.0/ | 3.125 | 0.023743/ | 1.480 | 98.520 |
| | ETFE | 0.0306 | 382.2 | 365.8 | | 0.060307 | | |
| 22 | 316LVM/ | 0.01205/ | 720/ | 12.2/ | 3.074 | 0.023696/ | 1.675 | 98.325 |
| | ETFE | 0.0306 | 382.2 | 371.8 | | 0.060188 | | |

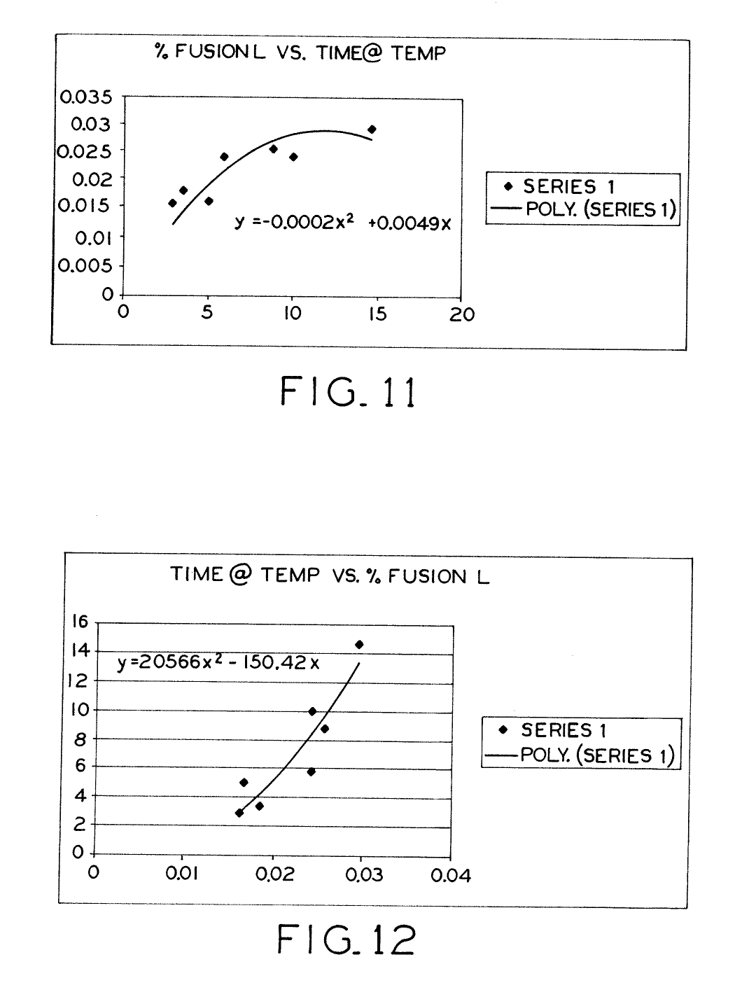

Plots of Reduction % vs. time at temperature, and time at temperature vs. Reduction %, are set forth in FIGS. 11 and 12, respectively.

As set forth in FIG. 11, a best fit curve of the data reveals the following relationship:

Reduction %=−0.002x²+0.0049x,

where x=time at temperature. As set forth in FIG. 12, a best fit curve of the data reveals the following relationship:

y=20566x²−150.42x,

where x=Reduction % and y=time at temperature.

As illustrated in Table 1 and FIGS. 11 and 12, Fusion % was consistently between 97% and 98.5%, with the corresponding Reduction % between 1.5% and 3%. Thus, each of the seven fused wire samples tested in this example retained a substantial amount of the dimensional characteristics of their component wires, as discussed above.

This Example also illustrates that line speed may be increased with increasing heating chamber temperature or decreased with decreasing heating chamber temperature, while still maintaining consistent characteristics of the fused wire product produced. As shown above, the highest heating chamber temperatures (sample #'s 3 and 4) were 47% higher than the lowest heating chamber temperature (sample #5), with time at temperature between 3 and 4 times longer for the lowest heating chamber temperature as compared to the highest heating chamber temperature. Despite these substantial variations in production variables, however, Fusion % and Reduction % varied less than 2%.

While this invention has been described as having an exemplary design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A fused wire, comprising:
a first wire including a first metal conductor surrounded by a first coating of insulation, said first wire having a first diameter D₁;
a second wire including a second metal conductor surrounded by a second coating of insulation, said second wire having a second diameter D₂; and
said first and second wires fused together along a line contact between said first and second coatings to form said fused wire, said fused wire having a major diameter D₃, said wire further having a value Fusion % according to the following formula:
Fusion %=[D₃/(D₁+D₂)]×100% (I)
wherein Fusion % is between 75% and 99.5%.

2. The fused wire of claim 1, wherein Fusion % is between 90% and 97%.

3. The fused wire of claim 1, wherein Fusion % is between 95% and 99%.

4. The fused wire of claim 1, wherein Fusion % is greater than 99%.

5. The fused wire of claim 1, wherein said first wire comprises a first cross-sectional size, said second wire comprises a second cross-sectional size, said first cross-sectional size different from said second cross-sectional size.

6. The fused wire of claim 1, wherein one of said first wire and said second wire comprises a ribbon.

7. The fused wire of claim 1, wherein at least one of said first metal conductor and said second metal conductor comprises one of a single-strand wire and a multi-strand wire.

8. The fused wire of claim 1, wherein said first coating of insulation has a first thickness, said second coating of insulation has a second thickness, said first thickness different from said second thickness.

9. A method of fusing a pair of coated wires, said method comprising the steps of:
providing at least first and second wires, each wire including a metal conductor surrounded by a coating of insulation;
paying the wires outwardly from at least one spool;
aligning the wires in abutting contact with one another along a line contact between the coatings of the wires; and
heating the wires while maintaining the wires in abutting contact with one another along the line contact to a temperature sufficient to fuse the coatings of the wires together along the line contact.

10. The method of claim 9, wherein said step of heating the wires comprises heating the coating of insulation of each of the first and second wires to a thermal transition temperature of at least one of the respective coatings of insulation.

11. The method of claim 9, wherein said step of aligning the wires in abutting contact comprises passing the first and second wires through a wire straightening device.

12. The method of claim 11, wherein the wire straightening device comprises a first row of rollers and a second row of rollers, said step of aligning the wires in abutting contact further comprising advancing the first and second wires along a direction substantially perpendicular to the axes of the rollers in the first row of rollers and the second row of rollers.

13. The method of claim 9, wherein said step of heating the wires comprises passing the wires through a heating device.

14. The method of claim 13, wherein the temperature sufficient to fuse the coatings of the wires together, in said step of heating the wires, is reached by at least one of:
selecting a length of the heating device;
selecting a speed at which the first and second wires travel through the heating device; and
selecting a temperature maintained within an internal heating chamber of the heating device.

15. The method of claim 14, wherein said step of selecting a length of the heating devices comprises:
selecting a number of heating devices; and
serially positioning each of the number of heating devices adjacent one another so that the first and second wires successively pass through the number of heating devices.

16. The method of claim 9, further comprising the step of tensioning the wires, said step of tensioning the wires comprising:
providing a capstan with at least one driven wheel;
wrapping the first and second wires around at least one pulley;
coupling the wires to the at least one driven wheel of the capstan; and
pulling the wires past the at least one pulley with the at least one driven wheel of the capstan.

17. The method of claim 9, further comprising the step, after said step of heating the wires, of:
cooling the wires; and
feeding the wire onto a take-up device.
